(19) United States
(12) Patent Application Publication
(10) Pub. No.: US 2010/0248204 A1
(43) Pub. Date: Sep. 30, 2010

(54) Interactive Media

(76) Inventor: Debra A. Meyering, Roselle, IL (US)

Correspondence Address: HARSHAW RESEARCH, INC., 210 W. TECUMSEH STREET, OTTAWA, KS, 66067, US

(21) Appl. No.: 12/410,103

(22) Filed: Mar. 24, 2009

(51) Int. Cl. G09B 5/06; G08B 13/14; G09B 5/04; B42D 1/00

(52) U.S. Cl. 434/309; 340/572.1; 434/317; 434/320; 281/15.1

(57) ABSTRACT

Interactive media includes first and second pages having a transmitter and a user input, a speaker, a microphone, and a receiver in communication with the transmitters. The interactive media includes an electronic memory device and a processor in communication with the speaker, microphone, receiver, and memory device. A mode device is in data communication with the processor to cause the processor to alter between a recording mode in which the processor is controlled by recording programming in the processor and a playback mode in which the processor is controlled by playback programming in the processor. The recording programming causes the processor to actuate the microphone and store audio data input through the microphone in the electronic memory device to correspond to a selected page. The playback programming causes the processor to actuate the speaker to present the stored audio data corresponding to a selected page.

### BACKGROUND OF THE INVENTION

This invention relates generally to audio books and, more particularly, to an interactive device that enables the voice of one user to be recorded in association with selected pages for later selective playback by another user.

The increased mobility and geographic separation of family networks often results in decreased interaction between grandparents and their grandchildren. For example, multiple siblings in a family may eventually reside in vastly separate regions of the country or even around the world such that the children of those siblings may have limited ability to physically spend time with their grandparents, aunts, uncles, and cousins.

One activity that is revered by both grandparents and their grandchildren is reading. More particularly, a grandmother particularly enjoys bonding with each grandchild by reading books to him or her. Conversely, a grandchild obtains fond memories of time spent with his grandmother enjoying a special book together. In fact, each child often has a special book that they associate with a grandparent or other relative or caregiver.

Various audio books have been proposed in the art for entertaining young children. Although assumably effective for their intended purposes, the existing devices and proposals do not adequately simulate the special experience of a parent or grandparent actually audibly reading a book to a child even though separated by a long distance. In other words, commercially pre-recorded books do not provide the grandparent's own voice to the child while the child looks at the book.

Therefore, it would be desirable to have interactive media having a recording mode that enables audio input data to be stored and associated with a selected page of the interactive media. Further, it would be desirable to have interactive media having a playback mode in which stored audio input data to be selectively played through a speaker.

### SUMMARY OF THE INVENTION

Interactive media according to a preferred embodiment of the present invention includes first and second pages having a transmitter and a user input, a speaker, a microphone, and a receiver in communication with the transmitters. The interactive media includes an electronic memory device and a processor in communication with the speaker, microphone, receiver, and memory device. A mode device is in data communication with the processor to cause the processor to alter between a recording mode in which the processor is controlled by recording programming in the processor and a playback mode in which the processor is controlled by playback programming in the processor. The recording programming causes the processor to actuate the microphone and store audio data input through the microphone in the electronic memory device to correspond to a selected page. The playback programming causes the processor to actuate the speaker to present the stored audio data corresponding to a selected page.

Therefore, a general object of this invention is to provide interactive media that enables voice input data to be recorded in association with selected pages of the media.

Another object of this invention is to provide interactive media, as aforesaid, that enables recorded voice input data to be played through a speaker upon demand associated with a selected page.

Still another object of this invention is to provide interactive media, as aforesaid, that is user-friendly both by the user recording voice data and the user causing selected voice data to be played back.

Yet another object of this invention is to provide interactive media, as aforesaid, in which audio data may be obtained from a home computer and communicated to the electronic media for storage.

A further object of this invention is to provide interactive media, as aforesaid, that includes a display, such as an electronic display screen, holographic display, or the like.

A still further object of this invention is to provide interactive media, as aforesaid, that essentially locks the device after recording and storing voice data so that it is not inadvertently overwritten.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of interactive media according to a preferred embodiment of the present invention;

FIG. 2 is an exploded view of the interactive media as in FIG. 1;

FIG. 3 is a block diagram illustrating the electronic components of the interactive media according to the present invention;

FIG. 4 is a flow chart depicting the logic performed by the processor according to the present invention; and

FIG. 5 is an isolated view on an enlarged scale of a key removed from the interactive media cover.

### DESCRIPTION OF THE PREFERRED EMBODIMENT

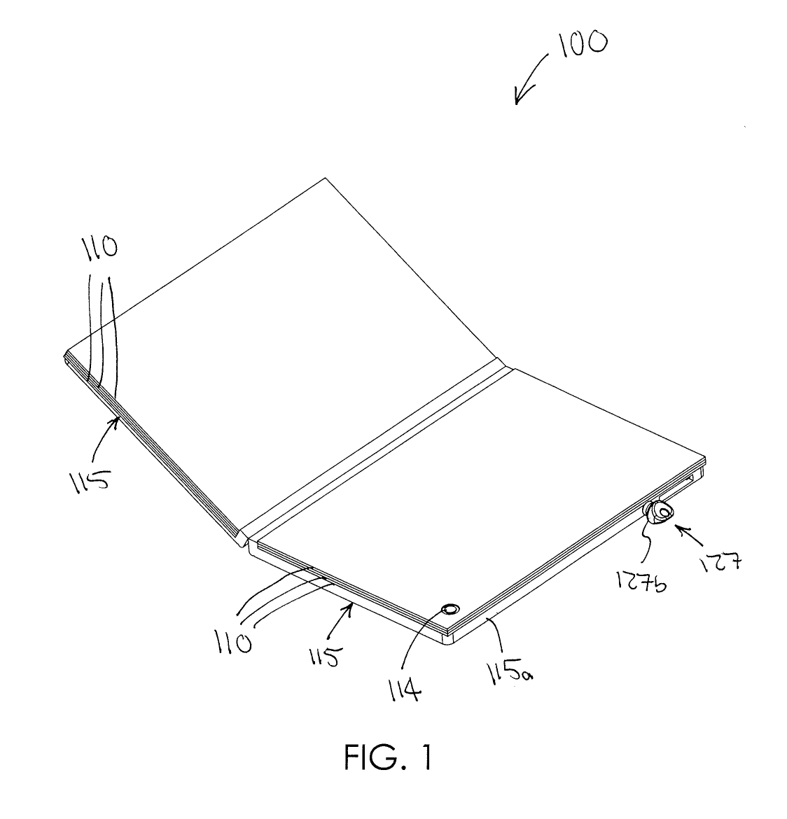

Interactive media will now be described in detail with reference to FIG. 1 through FIG. 5 of the accompanying drawings. More particularly, interactive media 100 according to one embodiment includes a plurality of pages 110 coupled together, such as a book.

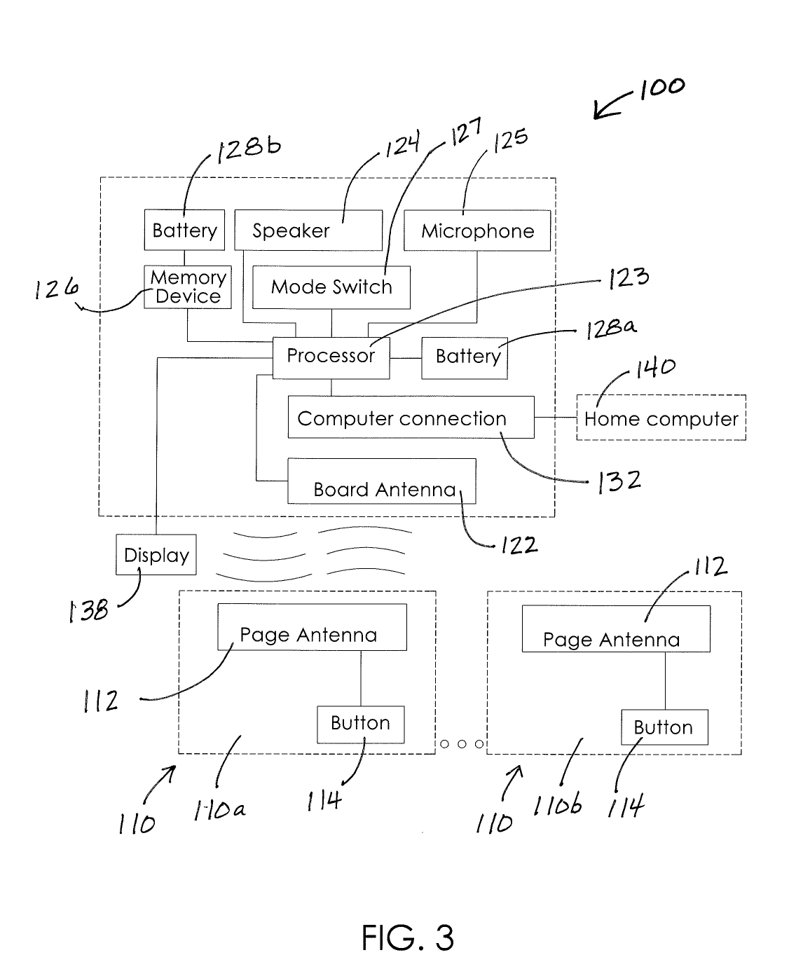

As shown in FIG. 1, a plurality of pages 110 may be included. Various pages 110 respectively have a transmitter 112 and a user input 114 (FIG. 1 and FIG. 3) and may include text, graphics, texture elements, and/or any other appropriate elements. Each user input 114 may be a button, switch, or any other appropriate input device. Separate from the pages 110, the interactive media 100 includes a receiver 122 (FIG. 3) for communicating with the transmitters 112. The transmitters 112 and the receiver 122 may communicate using RFID technology, audio frequency technology, or any other appropriate technology. RFID and other technologies that require only low amounts of power and that can be compactly packaged may be particularly well suited.

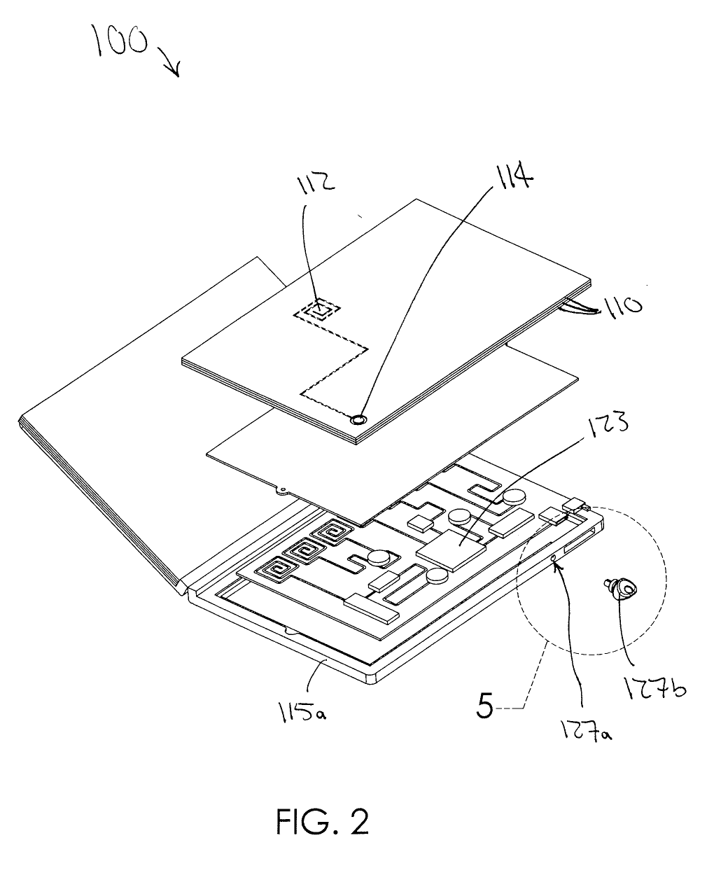

As shown in FIG. 3, the interactive media 100 may further include a processor 123, a speaker 124, a microphone 125, an electronic memory device 126, and a mode device 127. The processor 123 may be in data communication with the receiver 122, the speaker 124, the microphone 125, the electronic memory device 126, and the mode device 127, and each of these elements may be housed in a cover 115 operatively coupled to the pages 110 (e.g., a back cover 115a, as shown in FIG. 2). A primary power source 128a (e.g., a battery, AC current, etc.) is in electrical communication with the processor 123, the speaker 124, the microphone 125, the receiver 122, and the electronic memory device 126, and a secondary power source 128b (e.g., a battery) may be in electrical communication with the electronic memory device 126 so that data stored therein may be maintained even if the primary power source 128a is temporarily separated from the electronic memory device 126. Depending on the technology used for the electronic memory device 126, the secondary power source 128b may not be required to maintain the data stored in the electronic memory device 126.

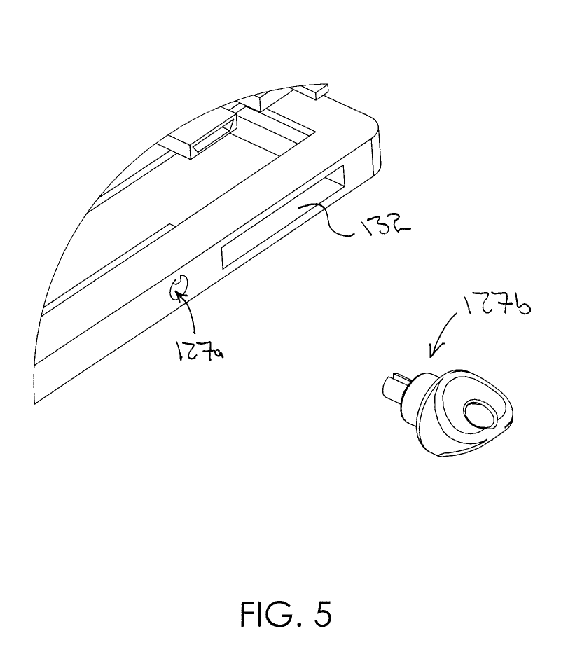

The mode device 127 may cause the processor 123 to alter between a recording mode in which the processor 123 is controlled by recording programming in the processor 123 and a playback mode in which the processor 123 is controlled by playback programming in the processor 123. The mode device 127 may include, for example, a contact 127a and a key 127b that is configured complementary to the contact 127a so that the key 127b may selectively interact with the contact 127a, as shown in FIG. 1, FIG. 2, and FIG. 5, and interaction between the key 127b and the contact 127a (FIG. 1) may cause the processor 123 to be in the recording mode. Separation of the key 127b from the contact 127a (FIG. 5) may cause the processor 123 to be in the playback mode. The key 127b may be configured such that it may selectively maintain interaction with the contact 127a. For example, the contact 127a may be recessed and the key 127b may have a friction fit with the back cover 115a. Alternately, the key 127b may be locked in place by rotating or sliding the key 127b in a complementary receiver, or a magnet may maintain interaction between the key 127b and the contact 127a, for example.

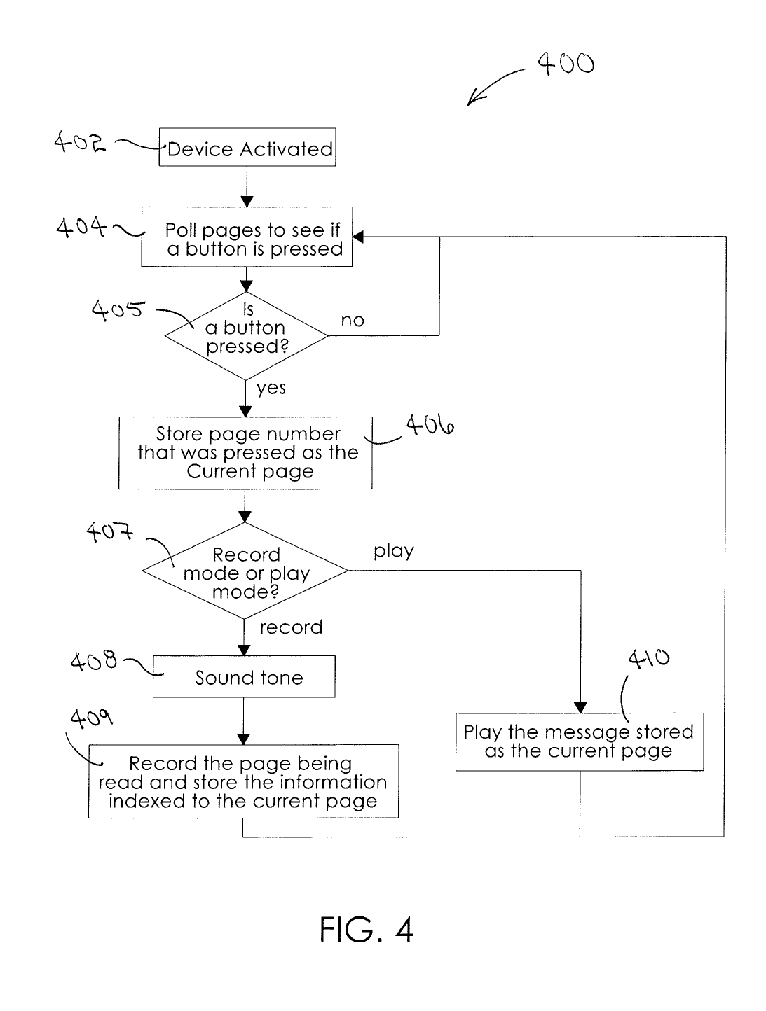

FIG. 4 shows a process 400 that helps in understanding the recording and playback modes. At step 402, the processor 123 is activated. This may be done through an input device, for example, or the processor 123 may be activated so long as the processor 123 is receiving power from the primary power source 128a. At steps 404 and 405, the processor determines if a user input 114 has been utilized. If not, the process 400 returns to step 404. If so, the process 400 proceeds to step 406.

At step 406, the processor 123 determines which user input 114 was utilized (e.g., whether the user input 114 of a first page 110a was utilized, whether the user input 114 of a second page 110b was utilized, etc.), and the process 400 continues to step 407. At step 407, the processor 123 determines whether the recording mode or the playback mode is currently selected by the mode device 127. If the recording mode is selected, the process 400 proceeds to steps 408 and 409; if the playback mode is selected, the process 400 proceeds to step 410.

At steps 408 and 409, the recording programming causes the processor 123 to actuate the microphone 125 and store audio data input through the microphone 125 in the electronic memory device 126. The audio data is stored in accordance with the determination made at step 406 regarding which user input 114 was utilized. For example, if the user input 114 of the first page 110a was utilized and the processor 123 is in the recording mode, the audio data input through the microphone 125 at steps 408 and 409 is stored in the electronic memory device 126 to correspond to the first page 110a; if the user input 114 of the second page 110b was utilized and the processor 123 is in the recording mode, the audio data input through the microphone 125 at steps 408 and 409 is stored in the electronic memory device 126 to correspond to the second page 110b; etc. The processor 123 may actuate the speaker 124 at step 408 to indicate that the microphone 125 is prepared to receive audio data. The process 400 continues from step 409 to step 404.

At step 410, the playback programming causes the processor 123 to actuate the speaker 124 to present audio data stored in the electronic memory device 126 that corresponds to the determination made at step 406 regarding which user input 114 was utilized. For example, if the user input 114 of the first page 110a was utilized and the processor 123 is in the playback mode, the audio data in the electronic memory device 126 that corresponds to the first page 110a is presented using the speaker 124; if the user input 114 of the second page 110b was utilized and the processor 123 is in the playback mode, the audio data in the electronic memory device 126 that corresponds to the second page 110b is presented using the speaker 124; etc. The process 400 continues from step 410 to step 404.

Returning to FIG. 3, means may also be included for remotely providing audio data that corresponds to the pages 110 to the processor 123 for storage in the electronic memory device 116. For example, as shown in FIG. 3 and FIG. 5, a port 132 may be in data communication with the processor 123, and the port 132 may be used to connect the processor 123 to a home computer 140. As such, audio data corresponding to the first page 110a may be obtained from the home computer 140 and stored in the electronic memory device 116 to correspond to the first page 110a, audio data corresponding to the second page 110b may be obtained from the home computer 140 and stored in the electronic memory device 116 to correspond to the second page 110b, etc. There may be a selection device in data communication with the processor 123 to cause the processor, while in the playback mode, to choose between audio data input through the microphone 125 and audio data input remotely.

In addition, a display 138 (e.g., a video display, an electronic picture display, a holographic display, etc.) may be included. The display 138 may be coupled to one of the covers 115 or pages 110 and may be in data communication with the processor 123. Visual data may be stored in the electronic memory device 126, and programming in the processor 123 may cause the processor 123 to actuate the display 138 to present the visual data upon the occurrence of a predetermined event (e.g., upon specific user input, after audio data from the last page 110 is presented, etc.).

In use, one person may record his voice to correspond to the various pages 110. This may be done, for example, as set forth above regarding the recording mode in FIG. 4. Alternately, it could be done remotely, such as through a remote computer that can access the home computer 140 via the Internet or by sharing data files, etc., and transferred to the electronic memory device 116, as discussed above. That recorded audio data may then be accessed while the processor 123 is in the playback mode by using the user inputs 114 of the pages 110, as generally set forth above regarding FIG. 4. This may allow a child or a second person to hear the recorded audio data from the person that recorded the audio data as the child or second person progresses through the pages 110. If the selection device is included to cause the processor 123, while in the playback mode, to choose between audio data input through the microphone 125 and audio data input remotely, the child or second person may choose which audio data will be presented. The display 138 may allow further customization, and may allow the person that recorded the audio data to be seen by the child or the second person, for example.

It is understood that while certain forms of this invention have been illustrated and described, it is not limited thereto except insofar as such limitations are included in the following claims and allowable functional equivalents thereof.

1. Interactive media, comprising:
a first page having a transmitter and a user input;
a second page having a transmitter and a user input;
a speaker;
a microphone;
a receiver for communicating with said transmitters;
an electronic memory device;
a processor in data communication with said speaker, said microphone, said receiver, and said electronic memory device;
a mode device in data communication with said processor to cause said processor to alter between a recording mode in which said processor is controlled by recording programming in said processor and a playback mode in which said processor is controlled by playback programming in said processor;
wherein said recording programming causes said processor to actuate said microphone and store audio data input through said microphone in said electronic memory device, respective audio data being stored to correspond to said first page upon activation of said first page user input in said recording mode, other respective audio data being stored to correspond to said second page upon activation of said second page user input in said recording mode; and
wherein said playback programming causes said processor to actuate said speaker to present said stored audio data corresponding to said first page upon activation of said first page user input in said playback mode, and to actuate said speaker to present said stored audio data corresponding to said second page upon activation of said second page user input in said playback mode.

2. The interactive media of claim 1, wherein:
a back cover is operatively coupled to said first and second pages; and
said speaker, said microphone, said receiver, said electronic memory device, and said processor are housed in said back cover.

3. The interactive media of claim 2, wherein:
said mode device includes a contact and a key configured complementary to said contact for selective interaction with said contact; and
interaction between said key and said contact causes said processor to be in said recording mode; and
separation of said key from said contact causes said processor to be in said playback mode.

4. The interactive media of claim 3, wherein said key is configured to selectively maintain interaction with said contact.

5. The interactive media of claim 4, further comprising:
a primary power source in electrical communication with said processor, said speaker, said microphone, said receiver, and said electronic memory device; and
a secondary power source in electrical communication with said electronic memory device.

6. The interactive media of claim 5, further comprising means for remotely providing audio data corresponding to said first and second pages to said processor for storage in said electronic memory device; wherein said playback programming causes said processor to actuate said speaker to present said remotely provided stored audio data corresponding to said first page upon activation of said first page user input in said playback mode; and wherein said playback programming causes said processor to actuate said speaker to present said remotely provided stored audio data corresponding to said second page upon activation of said second page user input in said playback mode.

7. The interactive media of claim 6, further comprising:
a display selected from the group consisting of a video display, a picture display, and a holographic display; the display being in data communication with said processor;
visual data stored in said electronic memory device; and
programming in said processor to actuate said display to present said visual data.

8. The interactive media of claim 7, wherein said first page transmitter, said second page transmitter, and said receiver communicate using RFID technology.

9. The interactive media of claim 1, wherein:
said mode device includes a contact and a key configured complementary to said contact for selective interaction with said contact; and
interaction between said key and said contact causes said processor to be in said recording mode; and
separation of said key from said contact causes said processor to be in said playback mode.

10. The interactive media of claim 9, wherein said key is configured to selectively maintain interaction with said contact.

11. The interactive media of claim 1, further comprising:
a primary power source in electrical communication with said processor, said speaker, said microphone, said receiver, and said electronic memory device; and
a secondary power source in electrical communication with said electronic memory device.

12. The interactive media of claim 1, further comprising means for remotely providing audio data corresponding to said first and second pages to said processor for storage in said electronic memory device; wherein said playback programming causes said processor to actuate said speaker to present said remotely provided stored audio data corresponding to said first page upon activation of said first page user input in said playback mode; and wherein said playback programming causes said processor to actuate said speaker to present said remotely provided stored audio data corresponding to said second page upon activation of said second page user input in said playback mode.

13. The interactive media of claim 1, further comprising:
a selection device in data communication with said processor to cause said processor in said playback mode to choose between said audio data input through said microphone and audio data input remotely; and
means for providing said remotely input audio data to said electronic memory device for storage, respective remotely input audio data being stored to correspond to said first page, other respective audio data being stored to correspond to said second page;
wherein said playback programming causes said processor to actuate said speaker to present said audio data input through said microphone corresponding to said first page upon activation of said first page user input in said playback mode while said processor has chosen said audio data input through said microphone;
wherein said playback programming causes said processor to actuate said speaker to present said audio data input through said microphone corresponding to said second page upon activation of said second page user input in said playback mode while said processor has chosen said audio data input through said microphone;
wherein said playback programming causes said processor to actuate said speaker to present said audio data input remotely corresponding to said first page upon activation of said first page user input in said playback mode while said processor has chosen said audio data input remotely; and
wherein said playback programming causes said processor to actuate said speaker to present said audio data input remotely corresponding to said second page upon activation of said second page user input in said playback mode while said processor has chosen said audio data input remotely.

14. The interactive media of claim 1, further comprising:
a display selected from the group consisting of a video display, a picture display, and a holographic display;
the display being in data communication with said processor;
visual data stored in said electronic memory device; and
programming in said processor to actuate said display to present said visual data.

15. The interactive media of claim 1, wherein said first page transmitter, said second page transmitter, and said receiver communicate using RFID technology.
